(19) United States
(12) Patent Application Publication
(10) Pub. No.: US 2026/0251221 A1
(43) Pub. Date: Aug. 27, 2026

(54) GATE VALVE, GATE VALVE SEAT SYSTEM, AND METHOD

(71) Applicant: Supreme Production Services, Inc., Corpus Christi, TX (US)

(72) Inventors: Lauren Gayle Tipps, Corpus Christi, TX (US); George Dewey Clark, IV, Orange Grove, TX (US)

(21) Appl. No.: 19/061,318

(22) Filed: Feb. 24, 2025

(51) Int. Cl. F16K 3/02; F16K 25/00

(52) U.S. Cl. CPC F16K 3/0227; F16K 25/005

(57) ABSTRACT

In some implementations, a gate valve includes a valve seat coaxially disposed about the fluid passage having a body end dimensioned and arranged to sealing engage a compressible seal disposed between a mating portion of the valve body and the body end, and a gate end comprising a valve seat surface dimensioned and arranged to sealing engage with a corresponding gate seat surface disposed on or into a corresponding side of the gate, wherein an uncompressed thickness of the compressible seal is greater than a seal distance determined between the mating portion of the valve body and the body end of the valve seat when the valve seat surface is sealing engaged with the gate seat surface such that the valve seat surface is sealing engaged with the valve body through the compressible seal and biased against the gate seat surface by the compressible seal. A gate valve seat system which includes a seat engagement tool, and a method of servicing a gate valve is also disclosed.

### FIELD

Embodiments of the present principles generally relate to a gate valve, a gate valve seal system, and methods utilizing a gate valve.

### BACKGROUND

Current gate valves are designed with a floating gate, wherein the seals are not actively biased against the gate. In floating gate valves, spaces or gaps exist between the surfaces of the gate and the valve seats. When pressurized during operation, the gate is pushed away from the inlet valve seat and towards the outlet valve seat if present, destroying the sealing contact between the valve seats and the gate. The floating gate design creates a gap between the gate and the valve seat. This gap between the gate and the valve seat allows fluids and solids to escape from the intended flowpath of the valve, typically entering the cavity of the valve body in which the gate is disposed. The leaking of fluid through the gap between the gate and the valve seat and into the valve body may remove necessary grease out of the valve body, result in accumulation of solids within the valve body, causing excessive damage to sealing surfaces and mechanical surfaces that may render the valve inoperable.

In addition, leaking of fluid through the gap between the gate and the valve seat and into the valve body may present significant safety issues, which may result in exposure of personnel to the chemicals flowing through the valve, as well as issues presented by malfunction or improper operation of the valve. The current “floating gate” design further requires constant maintenance and human interaction during operation in the field. There is a need to reduce or eliminate such safety concerns and human interaction related to gate valve operation in the field.

The inventors have provided a gate valve, a gate valve system, and improved methods for reducing or eliminating the leaking of fluid through the gap between the gate and the valve seat and into the valve body of a gate valve.

### SUMMARY

Embodiments of this disclosure relate to a gate valve having a preloaded seat. In other words, the disclosure relates to a gate valve in which the valve seat or seats are biased against the gate. Embodiments further include a gate valve system along with a tool useful in maintaining gate valves according to embodiments disclosed herein. Embodiments further include a gate valve system and method useful to operate a gate valve, and to retrofit an existing gate valve to convert a currently floating gate valve into a gate valve having a preloaded seat, wherein the valve seats are actively biased against the gate.

In embodiments, a gate valve comprises a valve body comprising an internal gate chamber and a fluid passage having a flowpath from an inlet to an outlet; a gate disposed within the internal gate chamber, movable between a closed position obstructing the flowpath through the fluid passage, and an open position allowing a fluid to flow from the inlet along the flowpath to the outlet; at least one valve seat having an inner-flowpath coaxially disposed about the fluid passage having a body end dimensioned and arranged to sealing engage a compressible seal disposed between a mating portion of the valve body and the body end, and a gate end comprising a valve seat surface dimensioned and arranged to sealing engage with a corresponding gate seat surface disposed on or into a corresponding side of the gate; wherein an uncompressed thickness of the compressible seal is greater than a seal distance determined between the mating portion of the valve body and the body end of the valve seat when the valve seat surface is sealing engaged with the gate seat surface such that the valve seat surface is sealing engaged with the valve body through the compressible seal and actively biased against the gate seat surface at least in part by the compressible seal.

In some embodiments, a gate valve comprises a valve body having an inlet side and an outlet side, comprising an internal gate chamber and a fluid passage having a flowpath from an inlet to an outlet; a gate disposed within the internal gate chamber, movable between a closed position obstructing the flowpath through the fluid passage, and an open position allowing a fluid to flow from the inlet along the flowpath to the outlet; an inlet valve seat coaxially disposed about a portion of the fluid passage disposed within the inlet side of the valve body, having an inlet body end dimensioned and arranged to sealing engage an inlet compressible seal disposed between an inlet mating portion of the valve body and the inlet body end, and an inlet gate end comprising an inlet valve seat surface dimensioned and arranged to sealing engage with a corresponding inlet gate seat surface disposed on or into an inlet side of the gate; an outlet valve seat coaxially disposed about a portion of the fluid passage disposed within the outlet side of the valve body, having an outlet body end dimensioned and arranged to sealing engage an outlet compressible seal disposed between an outlet mating portion of the valve body and the outlet body end, and an outlet gate end comprising an outlet valve seat surface dimensioned and arranged to sealing engage with a corresponding outlet gate seat surface disposed on or into an outlet side of the gate; wherein an uncompressed thickness of the inlet compressible seal is greater than an inlet seal distance determined between the inlet mating portion of the valve body and the inlet body end of the inlet valve seat when the inlet valve seat surface is sealing engaged with the inlet gate seat surface such that the inlet body end is sealing engaged with the inlet mating portion of the valve body through the inlet compressible seal and the inlet valve seat surface is actively biased against the inlet gate seat surface by the inlet compressible seal; and wherein an uncompressed thickness of the outlet compressible seal is greater than an outlet seal distance determined between the outlet mating portion of the valve body and the outlet body end of the outlet valve seat when the outlet valve seat surface is sealing engaged with the outlet gate seat surface such that the outlet body end is sealing engaged with the outlet mating portion through the outlet compressible seal and the outlet valve seat surface is actively biased against the outlet gate seat surface by the outlet compressible seal.

In embodiments, a gate valve seat system comprises a gate valve seat and a compressible seal concentrically disposable along a fluid path from a valve body inlet to a valve body outlet; the gate valve seat and the compressible seal dimensioned to be disposable between a mating potion of the valve body and a gate movable between a closed position and an open position; the gate valve seat comprising an inner-flowpath disposed therethrough between a body end separated from a gate end by a seat length; the body end dimensioned an arranged to engage the compressible seal disposed between the mating portion and the body end; the gate end comprising a valve seat surface dimensioned and arranged to sealingly engage a gate seat surface disposed on or into a corresponding side of the gate; wherein an uncompressed thickness of the compressible seal is greater than a seal distance determined between the mating portion and the body end when the valve seat surface is sealing engaged with the gate seat surface such that the body end is sealing engaged with the mating portion through the compressible seal, and the valve seat surface is actively biased against the gate seat surface at least in part by the compressible seal.

### BRIEF DESCRIPTION OF THE DRAWINGS

Embodiments of the present principles, briefly summarized above and discussed in greater detail below, can be understood by reference to the illustrative embodiments of the principles depicted in the appended drawings. However, the appended drawings illustrate only typical embodiments of the principles and are thus not to be considered limiting of scope, for the principles may admit to other equally effective embodiments.

FIG. 1 depicts a cross-sectional view of a gate valve in accordance with embodiments disclosed herein.

FIG. 2 depicts exploded area A shown in FIG. 1, depicting the interface of the valve seat with the valve body in accordance with embodiments disclosed herein.

FIG. 3 depicts exploded area B shown in FIG. 2, depicting the seal distance determined between the mating portion of the valve body and the body end of the valve seat when the valve seat surface is sealing engaged with the gate seat surface in accordance with embodiments disclosed herein.

FIG. 4A depicts a cross-sectional view of a gate valve equipped with a seat engagement tool without a gate in accordance with embodiments disclosed herein.

FIG. 4B depicts a cross-sectional view of a gate valve equipped with a seat engagement tool in accordance with embodiments disclosed herein.

FIG. 5 depicts a cross-sectional view of a seat engagement tool in accordance with embodiments disclosed herein.

FIG. 6 depicts exploded area A shown in FIG. 5, showing the engagement end of the seat engagement tool.

FIG. 7 depicts a cross-sectional view of a gate valve equipped with a seat engagement tool being employed for extraction of the seat in accordance with embodiments disclosed herein.

FIG. 8A shows a partial cross-sectional view of a compressible seal in accordance with embodiments disclosed herein.

FIG. 8B shows a partial cross-sectional view of a compressible seal in accordance with embodiments disclosed herein.

FIG. 8C shows a valve seat comprising a compound compressible seal in accordance with embodiments disclosed herein.

FIG. 8D shows an enlargement of section A shown in FIG. 8C.

FIG. 9A shows a partial cross-sectional view of a compressible seal in accordance with embodiments disclosed herein.

FIG. 9B shows a partial cross-sectional view of a compressible seal in accordance with embodiments disclosed herein.

FIG. 10 is a flowchart depicting a method of servicing a gate valve in accordance with embodiments disclosed herein.

### DETAILED DESCRIPTION

The embodiments of this disclosure relate to a gate valve having a preloaded valve seat, wherein the valve seat is biased against the gate via a compressible seal disposed between the valve body and the valve seat. Embodiments further include a gate valve system along with a tool useful in maintaining gate valves according to embodiments disclosed herein. Embodiments further include a gate valve system and method useful to operate a gate valve, and to retrofit an existing gate valve to convert a currently floating gate valve into a gate valve having a preloaded seat, wherein the valve seats are actively biased against the gate.

As noted herein, current “floating gate” designs of gate valves require constant maintenance and human interaction during operation in the field. There is a need to reduce or eliminate such safety concerns and human interaction related to gate valve operation in the field. Gate valves, systems, and methods according to embodiments disclosed herein utilize oversized seals i.e., compressible seals that are compressed before valve assembly. This is accomplished using a seat engagement tool according to embodiments disclosed herein. This seat engagement tool may be powered mechanically and/or hydraulically, and may be utilized to disassemble, and/or assemble a gate valve according to embodiments disclosed herein. Once the gate valve is assembled, the pressure is released from the seat engagement tool and the seat engagement tool is removed from the gate valve. The valve seats are retained within the gate valve with the compressible seals compressed and in a pre-loaded or energized state.

The oversized compressible seals apply the preload pressure to the valve seat and the valve body, thereby closing any gap between the gate and valve seat. By eliminating the gap caused by a “floating gate”, fluids and solids are less likely to enter the valve body. Accordingly, gate valves according to embodiments disclosed herein have an advantage of retaining lubricating grease in place which prevents damage to sealing and mechanical surfaces. Preventing these damages also allows for the gate valves to be fully operational while in the field and lowers the rebuild costs/turnaround time for repeated use.

In addition, other benefits include improved safety of the gate valves according to embodiments disclosed herein. In contrast to the current “floating gate” design which requires constant maintenance and thus human interaction during operation in the field, the gate valves disclosed herein provide successful job completion with essentially zero human interaction during operation in the field.

Gate valves known in the art which are designed with removeable seats have a common problem after assembly. Once assembled, and especially after use, the seats often become very difficult to remove. There are no features on valve seats that allow for a tool to engage the valve seat and be used to aid in removal. Embodiments disclosed herein include a seat engagement tool, e.g., a seat puller tool, which includes an expanding mandrel/collet design which allows the engagement tool to engage a smooth outside diameter for optimal surface contact when expanded against the internal diameter of the valve seat i.e., the inner-flowpath of the valve seat.

The seat engagement tool is operable to produce a contact pressure between the seat engagement tool and the valve seat which is greater than the force holding the valve seat in the valve body. The seat engagement tool may then be engaged with a hydraulic ram/cylinder and once hydraulic pressure is applied the puller tool will extract the seat from the valve body.

Without utilizing the seat engagement tool, the common options for seat removal in the art have been blunt force using hammers and chisels and/or gas cutting torch. Either of these methods damage the seat beyond use and in extreme cases damage can occur to the valve body. Seats and valve bodies are infinitely reusable when not severely damaged, thereby conserving resources.

In embodiments, a gate valve comprises a valve body comprising an internal gate chamber and a fluid passage having a flowpath from an inlet to an outlet; a gate disposed within the internal gate chamber, movable between a closed position obstructing the flowpath through the fluid passage, and an open position allowing a fluid to flow from the inlet along the flowpath to the outlet; at least one valve seat having an inner-flowpath coaxially disposed about the fluid passage having a body end dimensioned and arranged to sealing engage a compressible seal disposed between a mating portion of the valve body and the body end, and a gate end comprising a valve seat surface dimensioned and arranged to sealing engage with a corresponding gate seat surface disposed on or into a corresponding side of the gate.

In such embodiments, an uncompressed thickness of the compressible seal is greater than a seal distance determined between the mating portion of the valve body and the body end of the valve seat when the valve seat surface is sealing engaged with the gate seat surface. Stated another way, the thickness of the compressible seal which fills the space between the valve body and the end of the valve seat is oversized, exerting a force on the valve seat towards the gate such that the valve seat surface is sealing engaged with the valve body through the compressible seal and the valve seat is actively biased against the gate seat surface at least in part by the compressible seal, which in embodiments is by the compressible seal.

In embodiments, the uncompressed thickness of the compressible seal is greater than or equal to about 1.5× (one and one half times) the seal distance. In some embodiments, the uncompressed thickness of the compressible seal is greater than or equal to about twice the seal distance.

In embodiments, the compressible seal comprises, consists essentially of, or consists of an elastomer. In some embodiments, the compressible seal comprises EPDM, butyl rubber, nitrile rubber, nitrile butadiene rubber, hydrogenated nitrile butadiene rubber, perfluoroelastomer, fluorosilicone, neoprene, polytetrafluoroethylene, polyurethane, silicone rubber, fluoroelastomer (viton), natural rubber, polyisoprene, styrene butadiene rubber, vinyl rubber, PVC, or a combination thereof. In some embodiments, the compressible seal comprises an inner elastomeric core covered by a coating, wherein a hardness of the inner elastomeric core is less than a hardness of the coating. In some of such embodiments, the compressible seal comprises an inner elastomeric core comprising rubber and/or a fluorinated alkene polymer e.g., butyl rubber, a fluoroelastomer (e.g., Viton), and or the like, covered by a thermoplastic coating, e.g., a polyolefin and/or a polytetrafluoroethylene (PTFE, e.g., Teflon), TFE or ETFE. In embodiments, the compressible seal comprises a coating comprising PTFE or TFE encasing a fluoroelastomer (Viton) inner elastomeric core. In other embodiments, the compressible seal consists essentially of PTFE and/or TFE.

In embodiments, the compressible seal has a hardness of greater than or equal to about 50 Shore A. In some embodiments, the compressible seal has a hardness of greater than or equal to about 60 Shore A, or greater than or equal to about 70 Shore A, and less than or equal to about 100 Shore A.

In embodiments, the compressible seal comprises an outer coating encasing the inner elastomeric core. In embodiments, the inner elastomeric core has a hardness of greater than or equal to about 50 Shore A and less than about 100 Shore A. In some embodiments, the compressible seal has a hardness of greater than or equal to about 60 Shore A, or greater than or equal to about 70 Shore A, and less than or equal to about 100 Shore A; and the inner core has a hardness of greater than or equal to about 50 Shore D. In some embodiments, the coating has a hardness of greater than or equal to about 60 Shore D, or greater than or equal to about 70 Shore D, and less than or equal to about 100 Shore D.

In embodiments, the compressible seal has a hardness of greater than or equal to about 50 Shore D. In some embodiments, the compressible seal has a hardness of greater than or equal to about 60 Shore D, or greater than or equal to about 70 Shore D, and less than or equal to about 100 Shore D.

In embodiments, a gate valve comprises a valve body having an inlet side and an outlet side, comprising an internal gate chamber and a fluid passage having a flowpath from an inlet to an outlet; a gate disposed within the internal gate chamber, movable between a closed position obstructing the flowpath through the fluid passage, and an open position allowing a fluid to flow from the inlet along the flowpath to the outlet; an inlet valve seat coaxially disposed about a portion of the fluid passage disposed within the inlet side of the valve body, having an inlet body end dimensioned and arranged to sealing engage an inlet compressible seal disposed between an inlet mating portion of the valve body and the inlet body end, and an inlet gate end comprising an inlet valve seat surface dimensioned and arranged to sealing engage with a corresponding inlet gate seat surface disposed on or into an inlet side of the gate; an outlet valve seat coaxially disposed about a portion of the fluid passage disposed within the outlet side of the valve body, having an outlet body end dimensioned and arranged to sealing engage an outlet compressible seal disposed between an outlet mating portion of the valve body and the outlet body end, and an outlet gate end comprising an outlet valve seat surface dimensioned and arranged to sealing engage with a corresponding outlet gate seat surface disposed on or into an outlet side of the gate; wherein an uncompressed thickness of the inlet compressible seal is greater than an inlet seal distance determined between the inlet mating portion of the valve body and the inlet body end of the inlet valve seat when the inlet valve seat surface is sealing engaged with the inlet gate seat surface such that the inlet body end is sealing engaged with the inlet mating portion of the valve body through the inlet compressible seal and the inlet valve seat surface is actively biased against the inlet gate seat surface by the inlet compressible seal; and wherein an uncompressed thickness of the outlet compressible seal is greater than an outlet seal distance determined between the outlet mating portion of the valve body and the outlet body end of the outlet valve seat when the outlet valve seat surface is sealing engaged with the outlet gate seat surface such that the outlet body end is sealing engaged with the outlet mating portion through the outlet compressible seal and the outlet valve seat surface is actively biased against the outlet gate seat surface by the outlet compressible seal.

In some embodiments, the uncompressed thickness of the inlet compressible seal is greater than or equal to about 1.5 the inlet seal distance; and the uncompressed thickness of the outlet compressible seal is greater than or equal to about 1.5 the outlet seal distance. In embodiments, the uncompressed thickness of the inlet compressible seal and the uncompressed thickness of the outlet compressible seal are essentially equal such that preloading of the valve seat is equal on both sides of the gate.

In embodiments, the compressible seal comprises an inner portion having a circular cross section, and an outer portion having a rectangular cross section.

In embodiments, a gate valve seat system comprises a gate valve seat and a compressible seal concentrically disposable along a fluid path from a valve body inlet to a valve body outlet; the gate valve seat and the compressible seal dimensioned to be disposable between a mating potion of the valve body and a gate movable between a closed position and an open position; the gate valve seat comprising an inner-flowpath disposed therethrough between a body end separated from a gate end by a seat length; the body end dimensioned an arranged to engage the compressible seal disposed between the mating portion and the body end; the gate end comprising a valve seat surface dimensioned and arranged to sealingly engage a gate seat surface disposed on or into a corresponding side of the gate; wherein an uncompressed thickness of the compressible seal is greater than a seal distance determined between the mating portion and the body end when the valve seat surface is sealing engaged with the gate seat surface such that the body end is sealing engaged with the mating portion through the compressible seal, and the valve seat surface is actively biased against the gate seat surface at least in part by the compressible seal.

In embodiments, a retrofit kit comprises at least one valve seat having an inner-flowpath coaxially disposable about a fluid passage of a valve body, the valve sheet having a body end dimensioned and arranged to sealing engage a compressible seal disposed between a mating portion of the valve body and the body end, and a gate end comprising a valve seat surface dimensioned and arranged to sealing engage with a corresponding gate seat surface of said valve body disposed on or into a corresponding side of the gate; wherein an uncompressed thickness of the compressible seal is greater than a seal distance determined between the mating portion of the valve body and the body end of the valve seat when the valve seat surface is sealing engaged with the gate seat surface such that the valve seat surface is sealing engaged with the valve body through the compressible seal and biased against the gate seat surface by the compressible seal. Accordingly, in embodiments, an existing valve body may be retrofitted to include a pre-loaded valve seat arrangement according to embodiments disclosed herein via supplying a compressible seal and a replacement valve seat dimensioned and arranged according to embodiments disclosed herein. In other embodiments, an existing valve body may be retrofitted to include a pre-loaded valve seat arrangement according to embodiments disclosed herein via supplying a compressible seal and modifying an existing valve seat to have dimensions and arrangement according to embodiments disclosed herein.

In some embodiments of the gate valve seat system, the system further comprises a seat engagement tool disposable through at least one of the valve body inlet and the valve body outlet and having an engagement end disposable within the inner-flowpath of the gate valve seat configured to releasably engage the gate valve seat when disposed within the valve body; the seat engagement tool operable to engage the gate valve seat and move the engaged gate valve seat toward the mating portion of the valve body in an amount sufficient to compress the compressible seal and remove the bias between the valve seat surface and the gate seat surface, and/or to allow the gate to be operably disposed within the valve body; the seat engagement tool operable to be disengaged from the valve seat and removed from the valve body such that upon removal of the seat engagement tool, the body end is sealing engaged with the mating portion through the compressible seal, and the valve seat surface is actively biased against the gate seat surface by the compressible seal.

In embodiments of the gate valve seat system, the gate valve seat further comprises one or more engagement points disposed into a face of the inner-flowpath, releasably engageable by the engagement end of the seat engagement tool when disposed within the flowpath.

In embodiments, the engagement end of the seat engagement tool comprises an expandable collet having a tapered surface movably engageable with a corresponding tapered surface of a mandrel configured such that movement of the mandrel relative to the collet in a first direction causes the collet to expand and frictionally engage the inner-flowpath of the gate valve seat, and movement of the mandrel relative to the collet in a second direction opposite the first direction causes the collet to retract thereby disengaging the inner-flowpath of the gate valve seat. In embodiments, the seat engagement tool is at least partially disassembled and removed.

In embodiments, a method of servicing a gate valve according to embodiments disclosed herein comprises:
a) disposing a seat engagement tool through the inlet or the outlet and into the flowpath of the gate valve such that an engagement end of the seat engagement tool operable to engage the valve seat is disposed within the inner-flowpath of the valve seat; wherein the seat engagement tool is operable to engage the inner-flowpath of the gate valve seat and move the engaged gate valve seat toward the mating portion of the valve body;
b) engaging the inner-flowpath of the valve seat with the seat engagement tool; and
c) moving the engaged gate valve seat toward the mating portion of the valve body in an amount sufficient to compress the compressible seal and remove the bias between the valve seat surface and the gate seat surface, and/or to allow the gate to be operably disposed within the valve body. In embodiments, the method further includes:
d) disengaging the seat engagement tool from the valve seat; and
e) removing the seat engagement tool from the valve body such that upon removal of the seat engagement tool, the body end is sealing engaged with the mating portion through the compressible seal, and the valve seat surface is actively biased against the gate seat surface by the compressible seal.

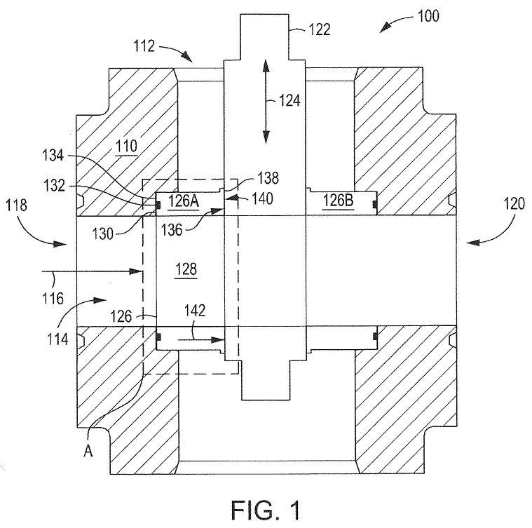

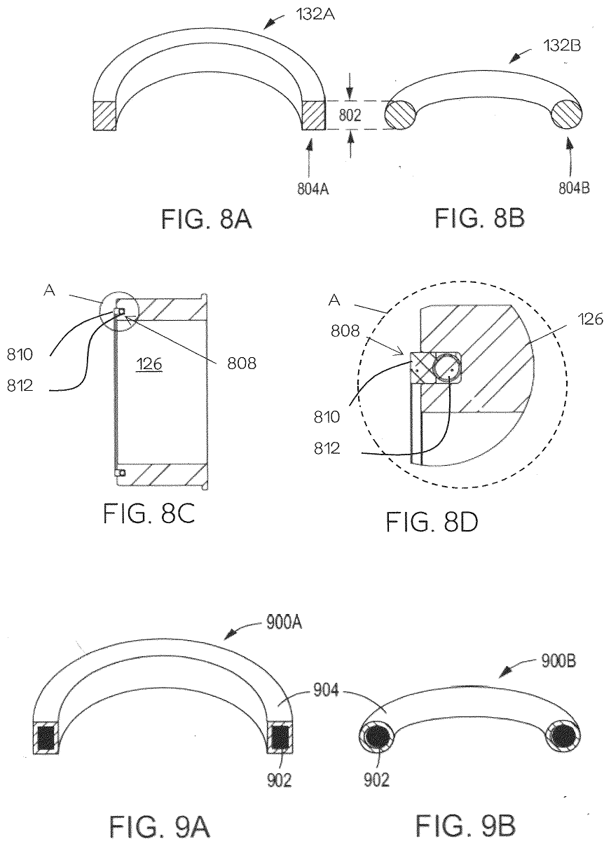

Turning to FIG. 1, depicting a cross-sectional view of a gate valve in accordance with embodiments disclosed herein, the gate valve 100 includes a valve body 110 comprising an internal gate chamber 112 and a fluid passage 114 having a flowpath 116 from an inlet 118 to an outlet 120 of the gate valve 100. The gate valve further includes a movable gate disposed within the internal gate chamber 112, movable 124 between a closed position obstructing the flowpath 116 through the fluid passage 114 (not shown), and an open position as shown in FIG. 1, allowing a fluid to flow from the inlet 118 along the flowpath 116 through an opening in the gate 122 to the outlet 120. The gate valve further includes at least one valve seat 126. Two valve seats 126 are shown in FIG. 1, an inlet valve seat 126A and an outlet valve seat 126B. The valve seat 126 having an inner-flowpath 128 coaxially disposed about the fluid passage 114 having a body end 130 dimensioned and arranged to sealing engage a compressible seal 132 disposed between a mating portion 134 of the valve body 110, and the body end 130. The valve seat 126 also includes a gate end 136 comprising a valve seat surface 138 dimensioned and arranged to sealing engage with a corresponding gate seat surface 140 disposed on or into a corresponding side of the gate 122, wherein the corresponding side of the gate 122 refers to the side of the gate 122 proximate to the particular valve seat 126. In embodiments, an uncompressed thickness 802 (see FIGS. 8A and 8B) of the compressible seal 132 is greater than a seal distance 300 (see FIG. 3) determined between the mating portion 134 of the valve body 110 and the body end 130 of the valve seat 126 when the valve seat surface 138 is sealing engaged with the gate seat surface 140 such that the valve seat surface 138 is sealing engaged with the valve body 110 through the compressible seal 132 and the valve seat surface 138 is actively biased (indicated as arrow 142) e.g., forced against the gate seat surface 140 by the compressible seal 132.

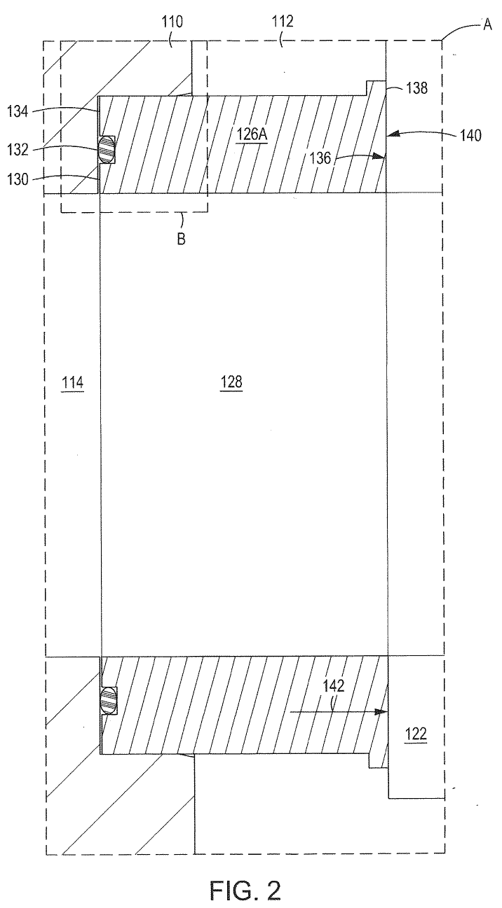

FIG. 2 depicts exploded area A shown in FIG. 1, depicting the sealing engagement between the body end 130 of the valve seat 126 and the mating portion 134 of the valve body 110 through the compressible seal 132. Also depicted in FIG. 2 is the sealing engagement between the valve seat surface 138 and the gate seat surface 140. In addition, as shown in FIG. 2, there may be metal to metal sealing engagement between the body end 130 of the valve seat 126 and the mating portion 134 of the valve body 110. In embodiments, one or more of the body end 130 of the valve seat 126 and the mating portion 134 of the valve body 110 may include one or more tapered surfaces which cooperate to form a seal (not shown).

FIG. 3 depicts exploded area B shown in FIG. 2, depicting an exaggerated seal distance 300 determined between the mating portion 134 of the valve body 110 and the body end 130 of the valve seat 126 when the valve seat surface 138 is sealing engaged with the gate seat surface 140 (shown in FIGS. 1 and 2) in accordance with embodiments disclosed herein. While FIG. 3 has been exaggerated to depict a space between the mating portion 134 of the valve body 110 and the body end 130 of the valve seat 126, such a space is not necessarily present.

Upon assembly of a gate valve according to embodiments disclosed herein, the valve seats are loaded into their respective slots disposed into the valve body with the compressible seal disposed in-between the valve body and the valve seal as depicted herein. However, by virtue of the compressible seal being oversized, the valve seats extend into the internal gate chamber and may prevent the gate from being operatively disposed into the gate valve. Accordingly, to either remove the gate from the gate valve, e.g., for maintenance, or to install the gate into the gate valve, the valve seats must be moved toward the mating portion of the valve body thereby compressing the compressible seal, i.e., preloading a force on the valve seat produced by compression of the compressible seal. In embodiments, a seat engagement tool is utilized.

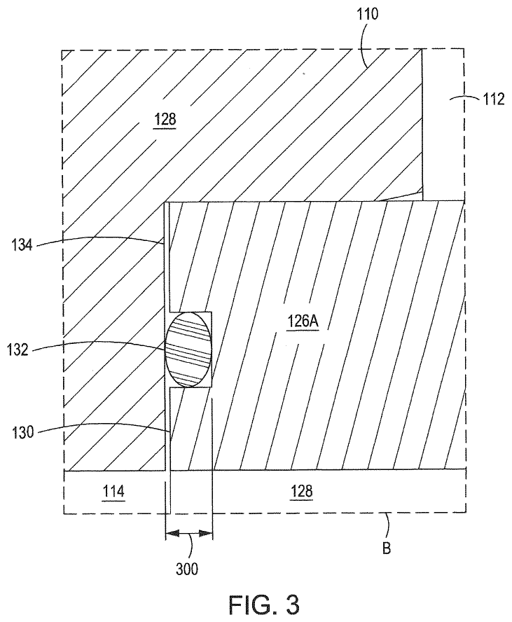

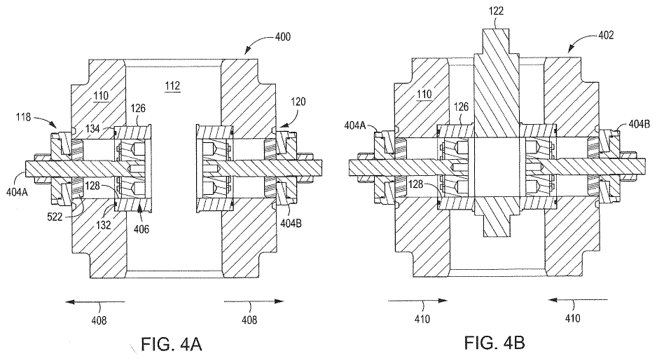

FIG. 4A depicts a cross-sectional view of a partially disassembled gate valve 400 equipped with a seat engagement tool, i.e., seat engagement tool 404A on an inlet of the gate valve, and a seat engagement tool 404B on the outlet of the gate valve. No gate is installed in the partially disassembled gate valve 400. FIG. 4B depicts a cross-sectional view of the gate valve shown in FIG. 4A, equipped with the seat engagement tools 404A and 404B, with the gate installed forming gate valve 402.

The seat engagement tool 404 is disposable through at least one of the valve body inlet 118 and the valve body outlet 120. The seat engagement tool 404 comprises an engagement end 406 disposable within the inner-flowpath 128 of the valve seat 126 and is configured to releasably engage the valve seat 126 when disposed within the valve body 110. As shown in FIG. 4A, the seat engagement tool 404 is operated to apply a force (depicted by arrow 408) on the valve seat 126 towards the mating portion 134 of the valve body 110, moving the valve seat 126 towards the mating portion 134 of the valve body 110, thereby compressing the compressible seal 132, allowing sufficient room and clearance to install the gate 122. Once the gate 122 is installed, as shown in FIG. 4B, the force applied by the seat engagement tool 404 may be removed, the seat engagement tool may be disengaged from the valve seat 126, and removed from the gate valve.

As such, the compressible seal 132 functions as a spring to provide a bias force of the valve seat 126 towards the gate 122 as indicated in FIG. 4B by arrows 410.

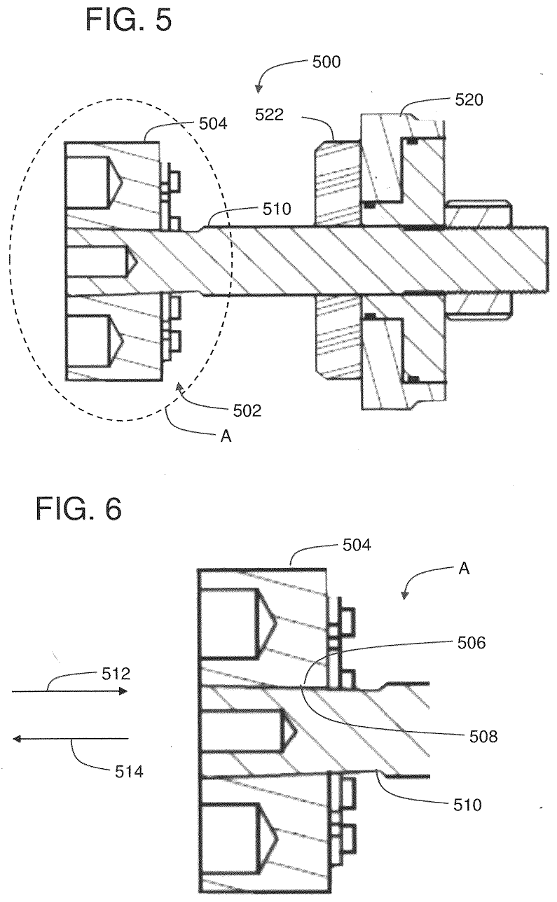

FIG. 5 depicts a cross-sectional view of another seat engagement tool 500 in accordance with embodiments disclosed herein. FIG. 6 depicts exploded area A shown in FIG. 5, showing the seat engagement end 502 of the other seat engagement tool 500.

As shown in FIG. 5, the seat engagement tool 500 comprises a seat engagement end 502 disposable within an inner-flowpath of the gate valve seat (See FIGS. 4A and 4B) and is configured to releasably engage the gate valve seat when disposed within the valve body. The seat engagement tool 500 is operable to engage the gate valve seat and move the engaged gate valve seat toward the mating portion of the valve body in an amount sufficient to compress the compressible seal and remove the bias between the valve seat surface and the gate seat surface, and/or to allow the gate to be operably disposed within the valve body. The seat engagement tool 500 is further operable to engage the gate valve seat and to remove the engaged gate valve from the valve body, e.g., a valve seat puller tool. The seat engagement tool 500 is further operable to be disengaged from the valve seat and be removed from the valve body such that upon removal of the seat engagement tool 500, the body end of the valve seat is sealing engaged with the mating portion of the valve body through the compressible seal, and the valve seat surface of the valve seat is actively biased against the gate seat surface of the gate by the compressible seal.

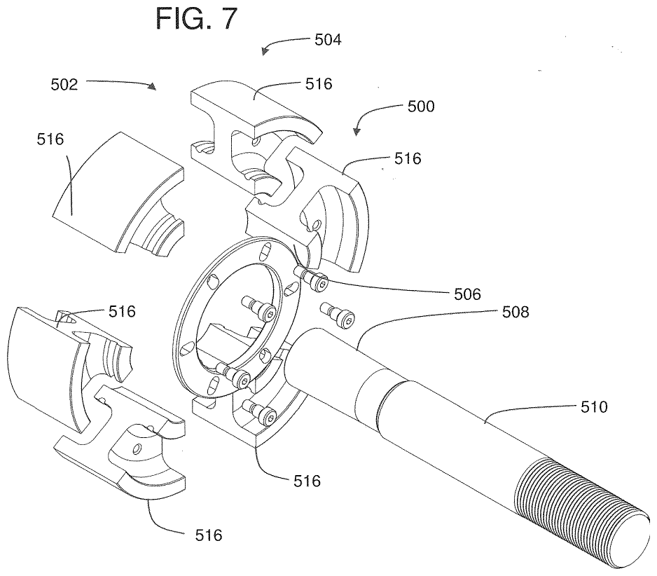

As shown in FIG. 7, in embodiments, the seat engagement tool 500 may be employed to extract a valve seat from the valve body by engaging the valve seat and applying a force (as indicated by arrow 702), which in embodiments includes actuation of a hydraulic cylinder (see FIG. 5) in a direction to move the valve seat away from the mating portion of the valve body, thereby extracting the valve seat from the valve body.

Returning to FIGS. 5 and 6, in embodiments, the seat engagement tool 500 frictionally engages the gate valve seat. In other embodiments, the gate valve seat further comprise one or more engagement points or features, e.g., slots, holes, chamfers, ridges, and/or the like, disposed into, or extending away from a face of the inner-flowpath of the valve seat, which cooperate with a corresponding portion of the seat engagement end 502 of the seat engagement tool 500 to allow engagement of the valve seat with the seat engagement tool 500.

As shown in FIG. 5, in embodiments the seat engagement tool 500 comprises a hydraulic cylinder 520, dimensioned and arranged to be larger than the inlet or outlet of the gate valve. Actuation of the hydraulic cylinder 520 exerts an outward force on the seat engagement tool 500 to either remove the valve seat from the valve body or compress the compressible seal to allow the gate to be inserted into the valve body, depending on the application and orientation of the seat engagement tool 500. In some embodiments, the seat engagement tool 500 comprises a bushing 522 dimensioned and arranged to fit within the inlet or outlet of the gate valve (see FIG. 4A) to align the seat engagement end 502 with the inner-flowpath of the valve seat. In still other embodiments, the hydraulic cylinder 520 is incorporated into or includes an external flange comprising a chamfer portion 524 extending away from the external flange dimensioned such that only a portion of the hydraulic cylinder 520 fits within the inlet or outlet of the gate valve to align the seat engagement end 502 with the inner-flowpath of the valve seat. In embodiments, during operation the hydraulic cylinder 520 is frictionally engaged with an outer surface of the valve body. In other embodiments, the external flange or hydraulic cylinder comprises holes 526 disposed therethrough to allow the external flange or hydraulic cylinder to be releasably attached to the valve body during operation.

As shown in more detail in FIG. 6, in embodiments, the seat engagement end 502 of the seat engagement tool 500 comprises an expandable collet 504 having a plurality of expandable collet blades or tines, each having a tapered surface 506 movably engageable with a corresponding tapered surface 508 of a mandrel 510 configured such that movement of the mandrel 510 relative to the collet 504 in a first direction 512, e.g., via turning threaded rod 516, causes the collet 504 to expand and frictionally engage the inner-flowpath of the gate valve seat; such arrangements are known in the art to be a cooperative taper configuration. In embodiments, the percentage of the taper determined as the change in diameter of the tapered surface of the mandrel shaft per unit of longitudinal distance along the main axis of the tapered surface of the mandrel shaft, is from about 0.5% to 7.5%, or from about 0.75% to 5%, or from about 1% to 4.5%. Likewise, movement of the mandrel 510 relative to the collet 504 in a second direction 514 opposite the first direction 512 causes the collet 504 to retract thereby disengaging the inner-flowpath of the gate valve seat.

In embodiments, the collet is configured to engage the inner-flowpath of the valve seat, which is coaxially disposed about the fluid passage between the body end and the gate end of the valve seat, i.e., the valve seat length. In embodiments, the corresponding surface of the collet, i.e., the thickness of the collet along the axis of the mandrel, is dimensioned and arranged to releasably engage at least about 50% of the valve seat length, or at least about 70% of the valve seat length, or at least about 95% of the valve seat length.

In embodiments, the surface of the collet which engages the valve seat is relatively smooth, such that engagement of the inner-flowpath of the valve seat by the collet does not adversely affect the inner-flowpath, e.g., marring of the inner-flowpath surface.

FIGS. 8A and 8B show a partial cross-sectional view of a compressible seal 132A and 132B, respectively, in accordance with embodiments disclosed herein. The compressible seal may be a single element, or may comprise a plurality of sealing elements, i.e., a plurality of compressible seals, used in combination. The compressible seal 132A or 132B has an uncompressed thickness 802 when not engaged within the gate valve. In embodiments, the uncompressed thickness 802 is greater than a seal distance 300 (see FIG. 3). In embodiments, the uncompressed thickness 802 is greater than or equal to about 1.5× (1.5 times) the seal distance, or greater than or equal to about 2× the seal distance, or greater than or equal to about 2.5× the seal distance, or greater than or equal to about 3× the seal distance. In embodiments, the uncompressed thickness of a compressible seal disposed within an inlet of the gate valve, i.e., an inlet compressible seal has an uncompressed thickness essentially equal to an uncompressed thickness of a compressible seal disposed within an outlet of the gate valve, i.e., an outlet compressible seal.

In embodiments, the uncompressed thickness of one of the inlet or outlet compressible seals is greater than the other. In embodiments, the uncompressed thickness of both the inlet and the outlet compressible seals are essentially equal, and the inlet seal distance different than the outlet seal distance, thereby applying a different bias pressure on one side of the gate relative to another.

As shown in FIG. 8A, in embodiments, the compressible seal 132A has a rectangular cross section 804, which for purposes herein includes a square cross section. As shown in FIG. 8B, in embodiments, the compressible seal 132 has circular cross section 804B. However, in other embodiments, the compressible seal may have a star shaped, or essentially any suitable cross section, as required for the particular end use. In embodiments, the compressible seal may comprise a plurality of seals stacked or engaged with one another.

FIG. 8C depicts a valve seat 126 equipped with a compound compressible seal 808 comprising a plurality of portions, e.g., an inner portion 812 and an outer portion 810. FIG. 8D depicts an enlargement of area A shown in FIG. 8C. Each portion of the compound compressible seal 808 may be the same or different in composition, cross section, structure, and/or the like. As shown in FIGS. 8C and 8D, in an embodiment, the compound compressible seal 808 comprises an inner portion 812 surrounded by an outer portion 810. As shown in FIGS. 8C and 8D, the inner portion 812 may having a round cross section, and the outer portion 810 may have rectangular cross section i.e., each portion has a different cross sectional shape.

The embodiment depicted in FIGS. 8C and 8D is for purposes of example only. It is to be understood that the various portions which form the compound compressible seal may independently have any suitable cross section. In embodiments, the cross section of the first portion may be the same or different than the cross section of second portion. In embodiments, the first portion may be separate from the second portion, e.g., two separate compressible seals. In other embodiments, the first portion may be engaged with, or part of the second portion, e.g., a single seal in which the first portion is attached to the second portion. Accordingly, in embodiments, the compressible seal is a compound compressible seal comprising a plurality of portions, each having a different cross sectional shape.

In embodiments, the compressible seal comprises, or is formed from a thermoplastic resin and/or a thermoset resin, and may be formed from PTFE and/or TFE. In embodiments, the compressible seal comprises an elastomer, which in embodiments comprises or is EPDM, butyl rubber, nitrile rubber, nitrile butadiene rubber, hydrogenated nitrile butadiene rubber, perfluoroelastomer, fluorosilicone, neoprene, polytetrafluoroethylene, polyurethane, silicone rubber, fluoroelastomer (viton), natural rubber, polyisoprene, styrene butadiene rubber, vinyl rubber, PVC, or a combination thereof. As shown in FIGS. 9A and 9B, in embodiments, the compressible seal 900A having a square cross section, or 900B having a circular cross section, comprise an inner elastomeric core 902 covered by an outer thermoplastic or thermoset coating 904, wherein a hardness of the inner elastomeric core 902 is less than a hardness of the coating 904. In embodiments, the inner elastomeric core 902 comprises another elastomer different from the coating 904. In embodiments, the inner coating 904 comprises a thermoplastic. In embodiments, the coating 904 comprises a metal. In embodiments, the coating 904 comprises, or is polytetrafluoroethylene, which covers the inner elastomeric core 902, which in embodiments comprises butyl rubber, and/or a fluoroelastomer, e.g., Viton. In some embodiments, the coating 904 is another elastomer.

In embodiments, the inner elastomeric core 902 comprises, or is a fluoroelastomer. In embodiments, the inner elastomeric core 902 has a Shore A hardness of greater than or equal to about 70 and less than or equal to about 80. In embodiments, the coating 904 comprises or is PTFE or TFE having a Shore D hardness of greater than or equal to about 50 and less than or equal to about 80.

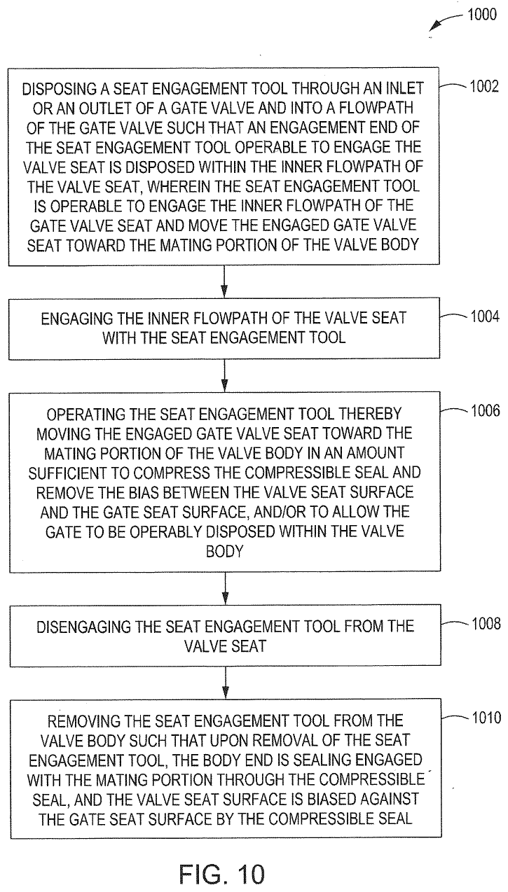

As shown in FIG. 10, in embodiments, a method of servicing a gate valve 1000 includes disposing a seat engagement tool through an inlet or an outlet of a gate valve according to one or more embodiments disclosed herein, and into a flowpath of the gate valve such that an engagement end of the seat engagement tool operable to engage the valve seat is disposed within the inner-flowpath of the valve seat, wherein the seat engagement tool is operable to engage the inner-flowpath of the valve seat and move the engaged valve seat toward the mating portion of the valve body (Block 1002); engaging the inner-flowpath of the valve seat with the seat engagement tool (Block 1004); and moving the engaged valve seat toward the mating portion of the valve body in an amount sufficient to compress the compressible seal and remove the bias between the valve seat surface and the gate seat surface, and/or to allow the gate to be operably disposed within the valve body (Block 1006). In embodiments, the method of servicing a gate valve 1000 may further include disengaging the seat engagement tool from the valve seat (Block 1008); and removing the seat engagement tool from the valve body such that upon removal of the seat engagement tool, the body end of the valve seat is sealing engaged with the mating portion of the valve body through the compressible seal, and the valve seat surface is biased against the gate seat surface by the compressible seal (Block 1010).

In embodiments, the method of servicing a gate valve 1000 may include additional blocks according to other embodiments disclosed herein. For example, the method may include removing of the valve seat from the valve body according to embodiments disclosed herein.

### EMBODIMENTS

The instant disclosure includes, but is not limited to the following embodiments.
E1. A gate valve comprising:
a valve body comprising an internal gate chamber and a fluid passage having a flowpath from an inlet to an outlet;
a gate disposed within the internal gate chamber, movable between a closed position obstructing the flowpath through the fluid passage, and an open position allowing a fluid to flow from the inlet along the flowpath to the outlet;
at least one valve seat having an inner-flowpath coaxially disposed about the fluid passage having a body end dimensioned and arranged to sealing engage a compressible seal disposed between a mating portion of the valve body and the body end, and a gate end comprising a valve seat surface dimensioned and arranged to sealing engage with a corresponding gate seat surface disposed on or into a corresponding side of the gate;
wherein an uncompressed thickness of the compressible seal is greater than a seal distance determined between the mating portion of the valve body and the body end of the valve seat when the valve seat surface is sealing engaged with the gate seat surface such that the valve seat surface is sealing engaged with the valve body through the compressible seal and biased against the gate seat surface at least in part by the compressible seal.
E2. The gate valve according to Embodiment E1, wherein the uncompressed thickness of the compressible seal is greater than or equal to about 1.5 the seal distance.
E3. The gate valve according to one or more of Embodiments E1-E2, wherein the uncompressed thickness of the compressible seal is greater than or equal to about twice the seal distance.
E4. The gate valve according to one or more of Embodiments E1-E3, wherein the compressible seal comprises an elastomer.
E5. The gate valve according to one or more of Embodiments E1-E4, wherein the compressible seal comprises EPDM, butyl rubber, nitrile rubber, nitrile butadiene rubber, hydrogenated nitrile butadiene rubber, perfluoroelastomer, fluorosilicone, neoprene, polytetrafluoroethylene, polyurethane, silicone rubber, fluoroelastomer (viton), natural rubber, polyisoprene, styrene butadiene rubber, vinyl rubber, PVC, or a combination thereof.
E6. The gate valve according to one or more of Embodiments E1-E5, wherein the compressible seal comprises an inner elastomeric core covered by a coating, wherein a hardness of the coating is greater than a hardness of the inner elastomeric core.
E7. The gate valve according to one or more of Embodiments E1-E6, wherein the compressible seal comprises an inner elastomeric core comprises a fluoroelastomer, and the coating comprises polytetrafluoroethylene.
E8. The gate valve according to Embodiment E7, wherein the polytetrafluoroethylene coating has a Shore D hardness of greater than or equal to about 50 and the inner elastomeric core comprising fluoroelastomer has a Shore A hardness of greater than or equal to about 60.
E9. The gate valve according to one or more of Embodiments E1-E8, wherein the compressible seal has a Shore A hardness of greater than or equal to about 50 and less than or equal to about 100.
E10. The gate valve according to one or more of Embodiments E1-E9, wherein the compressible seal has a Shore D hardness of greater than or equal to about 50 and less than or equal to about 100.
E10.1 The gate valve of claim 1, wherein the compressible seal is a compound compressible seal comprising a plurality of portions, each having a different cross sectional shape.
E11. A gate valve comprising:
   a valve body having an inlet side and an outlet side, comprising an internal gate chamber and a fluid passage having a flowpath from an inlet to an outlet; a gate disposed within the internal gate chamber, movable between a closed position obstructing the flowpath through the fluid passage, and an open position allowing a fluid to flow from the inlet along the flowpath to the outlet;
   an inlet valve seat coaxially disposed about a portion of the fluid passage disposed within the inlet side of the valve body, having an inlet body end dimensioned and arranged to sealing engage an inlet compressible seal disposed between an inlet mating portion of the valve body and the inlet body end, and an inlet gate end comprising an inlet valve seat surface dimensioned and arranged to sealing engage with a corresponding inlet gate seat surface disposed on or into an inlet side of the gate;
   an outlet valve seat coaxially disposed about a portion of the fluid passage disposed within the outlet side of the valve body, having an outlet body end dimensioned and arranged to sealing engage an outlet compressible seal disposed between an outlet mating portion of the valve body and the outlet body end, and an outlet gate end comprising an outlet valve seat surface dimensioned and arranged to sealing engage with a corresponding outlet gate seat surface disposed on or into an outlet side of the gate;
   wherein an uncompressed thickness of the inlet compressible seal is greater than an inlet seal distance determined between the inlet mating portion of the valve body and the inlet body end of the inlet valve seat when the inlet valve seat surface is sealing engaged with the inlet gate seat surface such that the inlet body end is sealing engaged with the inlet mating portion of the valve body through the inlet compressible seal and the inlet valve seat surface is biased against the inlet gate seat surface by the inlet compressible seal; and
   wherein an uncompressed thickness of the outlet compressible seal is greater than an outlet seal distance determined between the outlet mating portion of the valve body and the outlet body end of the outlet valve seat when the outlet valve seat surface is sealing engaged with the outlet gate seat surface such that the outlet body end is sealing engaged with the outlet mating portion through the outlet compressible seal and the outlet valve seat surface is biased against the outlet gate seat surface by the outlet compressible seal.
E12. The gate valve according to one or more of Embodiments E1-E11, wherein both the inlet compressible seal and the outlet compressible seal comprise a polytetrafluoroethylene coating covering a rubber core.
E13. The gate valve according to one or more of Embodiments E1-E12, wherein the uncompressed thickness of the inlet compressible seal is greater than or equal to about 1.5 the inlet seal distance; and wherein the uncompressed thickness of the outlet compressible seal is greater than or equal to about 1.5 the outlet seal distance.
E14. The gate valve according to one or more of Embodiments E1-E13, wherein the compressible seal is a compound compressible seal comprising an inner portion having a circular cross section, and an outer portion having a rectangular cross section.
E15. A gate valve seat system comprising a gate valve according to one or more of Embodiments E1-E14 and a compressible seal concentrically disposable along a fluid path from a valve body inlet to a valve body outlet.
E16. A gate valve seat system, comprising:
   a gate valve seat and a compressible seal concentrically disposable along a fluid path from a valve body inlet to a valve body outlet,
   the gate valve seat and the compressible seal dimensioned to be disposable between a mating portion of the valve body and a gate movable between a closed position and an open position;
   the gate valve seat comprising an inner-flowpath disposed therethrough between a body end separated from a gate end by a seat length;
   the body end dimensioned and arranged to engage the compressible seal disposed between the mating portion and the body end;
   the gate end comprising a valve seat surface dimensioned and arranged to sealingly engage a gate seat surface disposed on or into a corresponding side of the gate;
   wherein an uncompressed thickness of the compressible seal is greater than a seal distance determined between the mating portion and the body end when the valve seat surface is sealing engaged with the gate seat surface such that the body end is sealing engaged with the mating portion through the compressible seal, and the valve seat surface is biased against the gate seat surface at least in part by the compressible seal.
E17. The gate valve seat system according to one or more of Embodiments E15-E16, further comprising:
   a seat engagement tool disposable through at least one of the valve body inlet and the valve body outlet and having an engagement end disposable within the inner-flowpath of the gate valve seat configured to releasably engage the gate valve seat when disposed within the valve body;
   the seat engagement tool operable to engage the gate valve seat and move the engaged gate valve seat toward the mating portion of the valve body in an amount sufficient to compress the compressible seal and remove the bias between the valve seat surface and the gate seat surface, and/or to allow the gate to be operably disposed within the valve body;
   the seat engagement tool operable to be disengaged from the valve seat and removed from the valve body such that upon removal of the seat engagement tool, the body end is sealing engaged with the mating portion through the compressible seal, and the valve seat surface is biased against the gate seat surface at least in part by the compressible seal.
E18. The gate valve seat system according to one or more of Embodiments E15-E17, wherein the gate valve seat further comprise one or more engagement points disposed into a face of the inner-flowpath, releasably engageable by the engagement end of the seat engagement tool when disposed within the flowpath.
E19. The gate valve seat system according to one or more of Embodiments E15-E18, wherein the engagement end of the seat engagement tool comprises an expandable collet having a tapered surface movably engageable with a corresponding tapered surface of a mandrel configured such that movement of the mandrel relative to the collet in a first direction causes the collet to expand and frictionally engage the inner-flowpath of the gate valve seat, and movement of the mandrel relative to the collet in a second direction opposite the first direction causes the collet to retract thereby disengaging the inner-flowpath of the gate valve seat.
E20. The gate valve seat system according to Embodiment E19, wherein a percentage of taper of the tapered surface of the mandrel, determined as the change in diameter of the tapered surface of the mandrel shaft per unit of longitudinal distance along a main axis of the mandrel shaft, is from about 0.5% to 7.5%.
E21. The gate valve seat system according to one or more of Embodiments E19-E20, wherein a surface of the expandable collet is dimensioned and arranged to releasably engage at least about 50% of the valve seat length, or at least about 70% of the valve seat length, or at least about 95% of the valve seat length.
E22. A gate valve retrofit kit comprising a gate valve seat system according to one or more of Embodiments E16-E22.
E23. A method of servicing a gate valve, comprising:
   disposing a seat engagement tool through the inlet or the outlet and into the flowpath of the gate valve according to one or more of Embodiments E1-E14 such that an engagement end of the seat engagement tool operable to engage the valve seat is disposed within the inner-flowpath of the valve seat,
   wherein the seat engagement tool is operable to engage the inner-flowpath of the valve seat and move the engaged valve seat toward the mating portion of the valve body;
   engaging the inner-flowpath of the valve seat with the seat engagement tool; and
   moving the engaged valve seat toward the mating portion of the valve body in an amount sufficient to compress the compressible seal and remove the bias between the valve seat surface and the gate seat surface, and/or to allow the gate to be operably disposed within the valve body.
E24. The method according to Embodiment E23, further comprising disengaging the seat engagement tool from the valve seat; and
   removing the seat engagement tool from the valve body such that upon removal of the seat engagement tool, the body end is sealing engaged with the mating portion through the compressible seal, and the valve seat surface is biased against the gate seat surface at least in part by the compressible seal.

While the foregoing is directed to embodiments of the present principles, other and further embodiments of the principles may be devised without departing from the basic scope thereof.

What is claimed is:

1. A gate valve comprising:
a valve body comprising an internal gate chamber and a fluid passage having a flowpath from an inlet to an outlet;
a gate disposed within the internal gate chamber, movable between a closed position obstructing the flowpath through the fluid passage, and an open position allowing a fluid to flow from the inlet along the flowpath to the outlet;
at least one valve seat having an inner-flowpath coaxially disposed about the fluid passage having a body end dimensioned and arranged to sealing engage a compressible seal disposed between a mating portion of the valve body and the body end, and a gate end comprising a valve seat surface dimensioned and arranged to sealing engage with a corresponding gate seat surface disposed on or into a corresponding side of the gate;
wherein an uncompressed thickness of the compressible seal is greater than a seal distance determined between the mating portion of the valve body and the body end of the valve seat when the valve seat surface is sealing engaged with the gate seat surface such that the valve seat surface is sealing engaged with the valve body through the compressible seal and biased against the gate seat surface at least in part by the compressible seal.

2. The gate valve of claim 1, wherein the uncompressed thickness of the compressible seal is greater than or equal to about 1.5 the seal distance.

3. The gate valve of claim 1, wherein the compressible seal comprises an elastomer.

4. The gate valve of claim 1, wherein the compressible seal comprises EPDM, butyl rubber, nitrile rubber, nitrile butadiene rubber, hydrogenated nitrile butadiene rubber, perfluoroelastomer, fluorosilicone, neoprene, polytetrafluoroethylene, polyurethane, silicone rubber, fluoroelastomer (viton), natural rubber, polyisoprene, styrene butadiene rubber, vinyl rubber, PVC, or a combination thereof.

5. The gate valve of claim 1, wherein the compressible seal comprises an inner elastomeric core covered by a coating, wherein a hardness of the inner elastomeric core is less than a hardness of the coating.

6. The gate valve of claim 1, wherein the compressible seal comprises an inner elastomeric core comprising a fluoroelastomer, covered by a coating comprising polytetrafluoroethylene.

7. The gate valve of claim 7, wherein the coating has a Shore D hardness of greater than or equal to about 50 and the inner elastomeric core has a Shore A hardness of greater than or equal to about 60.

8. The gate valve of claim 1, wherein the compressible seal has a Shore A hardness of greater than or equal to about 50 and less than or equal to about 100.

9. The gate valve of claim 1, wherein the compressible seal has a Shore D hardness of greater than or equal to about 50 and less than or equal to about 100.

10. The gate valve of claim 1, wherein the compressible seal is a compound compressible seal comprising a plurality of portions, each having a different cross sectional shape.

11. A gate valve comprising:
a valve body having an inlet side and an outlet side, comprising an internal gate chamber and a fluid passage having a flowpath from an inlet to an outlet; a gate disposed within the internal gate chamber, movable between a closed position obstructing the flowpath through the fluid passage, and an open position allowing a fluid to flow from the inlet along the flowpath to the outlet;
an inlet valve seat coaxially disposed about a portion of the fluid passage disposed within the inlet side of the valve body, having an inlet body end dimensioned and arranged to sealing engage an inlet compressible seal disposed between an inlet mating portion of the valve body and the inlet body end, and an inlet gate end comprising an inlet valve seat surface dimensioned and arranged to sealing engage with a corresponding inlet gate seat surface disposed on or into an inlet side of the gate;
an outlet valve seat coaxially disposed about a portion of the fluid passage disposed within the outlet side of the valve body, having an outlet body end dimensioned and arranged to sealing engage an outlet compressible seal disposed between an outlet mating portion of the valve body and the outlet body end, and an outlet gate end comprising an outlet valve seat surface dimensioned and arranged to sealing engage with a corresponding outlet gate seat surface disposed on or into an outlet side of the gate;
wherein an uncompressed thickness of the inlet compressible seal is greater than an inlet seal distance determined between the inlet mating portion of the valve body and the inlet body end of the inlet valve seat when the inlet valve seat surface is sealing engaged with the inlet gate seat surface such that the inlet body end is sealing engaged with the inlet mating portion of the valve body through the inlet compressible seal and the inlet valve seat surface is biased against the inlet gate seat surface by the inlet compressible seal; and
wherein an uncompressed thickness of the outlet compressible seal is greater than an outlet seal distance determined between the outlet mating portion of the valve body and the outlet body end of the outlet valve seat when the outlet valve seat surface is sealing engaged with the outlet gate seat surface such that the outlet body end is sealing engaged with the outlet mating portion through the outlet compressible seal and the outlet valve seat surface is biased against the outlet gate seat surface by the outlet compressible seal.

12. The gate valve of claim 11, wherein both the inlet compressible seal and the outlet compressible seal comprise an inner elastomeric core comprising rubber covered by a polytetrafluoroethylene coating.

13. The gate valve of claim 11, wherein the uncompressed thickness of the inlet compressible seal is greater than or equal to about 1.5 the inlet seal distance; and wherein the uncompressed thickness of the outlet compressible seal is greater than or equal to about 1.5 the outlet seal distance.

14. The gate valve of claim 11, wherein the compressible seal is a compound compressible seal comprising an inner portion having a circular cross section, and an outer portion having a rectangular cross section.

15. A gate valve seat system, comprising:
a gate valve seat and a compressible seal concentrically disposable along a fluid path from a valve body inlet to a valve body outlet,
the gate valve seat and the compressible seal dimensioned to be disposable between a mating portion of the valve body and a gate movable between a closed position and an open position;
the gate valve seat comprising an inner-flowpath disposed therethrough between a body end separated from a gate end by a seat length;
the body end dimensioned and arranged to engage the compressible seal disposed between the mating portion and the body end;
the gate end comprising a valve seat surface dimensioned and arranged to sealingly engage a gate seat surface disposed on or into a corresponding side of the gate;
wherein an uncompressed thickness of the compressible seal is greater than a seal distance determined between the mating portion and the body end when the valve seat surface is sealing engaged with the gate seat surface such that the body end is sealing engaged with the mating portion through the compressible seal, and the valve seat surface is biased against the gate seat surface at least in part by the compressible seal.

16. The gate valve seat system of claim 15, further comprising:
a seat engagement tool disposable through at least one of the valve body inlet and the valve body outlet and having an engagement end disposable within the inner-flowpath of the gate valve seat configured to releasably engage the gate valve seat when disposed within the valve body;
the seat engagement tool operable to engage the gate valve seat and move the engaged gate valve seat toward the mating portion of the valve body in an amount sufficient to compress the compressible seal and remove the bias between the valve seat surface and the gate seat surface, and/or to allow the gate to be operably disposed within the valve body;
the seat engagement tool operable to be disengaged from the valve seat and removed from the valve body such that upon removal of the seat engagement tool, the body end is sealing engaged with the mating portion through the compressible seal, and the valve seat surface is biased against the gate seat surface at least in part by the compressible seal.

17. The gate valve seat system of claim 16, wherein the gate valve seat further comprises one or more engagement points disposed into a face of the inner-flowpath, releasably engageable by the engagement end of the seat engagement tool when disposed within the flowpath.

18. The gate valve seat system of claim 16, wherein the engagement end of the seat engagement tool comprises an expandable collet having a tapered surface movably engageable with a corresponding tapered surface of a mandrel configured such that movement of the mandrel relative to the collet in a first direction causes the collet to expand and frictionally engage the inner-flowpath of the gate valve seat, and movement of the mandrel relative to the collet in a second direction opposite the first direction causes the collet to retract thereby disengaging the inner-flowpath of the gate valve seat.

19. A method of servicing a gate valve, comprising:
disposing a seat engagement tool through the inlet or the outlet and into the flowpath of the gate valve of claim 1 such that an engagement end of the seat engagement tool operable to engage the valve seat is disposed within the inner-flowpath of the valve seat,
wherein the seat engagement tool is operable to engage the inner-flowpath of the valve seat and move the engaged valve seat toward the mating portion of the valve body;
engaging the inner-flowpath of the valve seat with the seat engagement tool; and
moving the engaged valve seat toward the mating portion of the valve body in an amount sufficient to compress the compressible seal and remove the bias between the valve seat surface and the gate seat surface, and/or to allow the gate to be operably disposed within the valve body.

20. The method of claim 19, further comprising disengaging the seat engagement tool from the valve seat; and
removing the seat engagement tool from the valve body such that upon removal of the seat engagement tool, the body end is sealing engaged with the mating portion through the compressible seal, and the valve seat surface is biased against the gate seat surface by the compressible seal.
